(19) United States
(12) Patent Application Publication
(10) Pub. No.: US 2025/0344817 A1
(43) Pub. Date: Nov. 13, 2025

(54) Button Product Manufacturing Device

(71) Applicant: Brother Kogyo Kabushiki Kaisha, Nagoya (JP)

(72) Inventors: Yuji Koga, Nagoya (JP); Kenji Takeuchi, Nagoya (JP); Yoji Tsujishita, Ichinomiya-shi (JP)

(21) Appl. No.: 19/276,253

(22) Filed: Jul. 22, 2025

Related U.S. Application Data
(63) Continuation of application No. PCT/JP2024/000577, filed on Jan. 12, 2024.

(30) Foreign Application Priority Data
Jan. 23, 2023 (JP) 2023-007926

(51) Int. Cl. A44C 27/00; A44C 3/00; B41J 2/175; B41J 3/407

(52) U.S. Cl. CPC A44C 27/00; B41J 2/17503; B41J 3/407; A44C 3/001

(57) ABSTRACT

A button product manufacturing device includes a printer including a housing including a cassette configured to accommodate a print medium and a first accommodation chamber configured to accommodate the cassette, and the printer being configured to perform printing on the print medium, a die set configured to connect a front member covered with the print medium and a back member to each other to manufacture a button product, and a conveyor that is configured to convey the print medium from the printer to above the front member in the die set, the conveyor being configured to be attached to and detached from the housing. A direction in which the cassette is pulled out from the first accommodation chamber and a detachment direction in which the conveyor is detached from the housing are the same.

### REFERENCE TO RELATED APPLICATIONS

This is a continuation application of International Application No. PCT/JP2024/000577 filed on Jan. 12, 2024, which claims priority from Japanese Patent Application No. 2023-007926 filed on Jan. 23, 2023. The entire contents of the aforementioned applications are incorporated herein by reference.

### BACKGROUND ART

A button product manufacturing device in a related art is known. This button product manufacturing device manufactures a button product by covering a front lid with a film on which a predetermined image is printed and sandwiching, between the front lid and a back lid, a portion of the film protruding from the front lid.

In the related art, members such as the film, the front lid, and the back lid for manufacturing the button product have to be loaded in the button product manufacturing device. When a failure or the like occurs at a time of manufacturing the button product, a component of the button product manufacturing device may have to be detached. The above related art does not consider convenience in an operation for manufacturing the button product, such as the loading of the members and attachment and detachment of the component as described above, and there is a problem in this respect.

Therefore, an object of the present disclosure is to provide a button product manufacturing device capable of performing an operation for manufacturing a button product from a specific direction.

### SUMMARY

A button product manufacturing device including:
a printer including a housing including a cassette configured to accommodate a print medium and a first accommodation chamber configured to accommodate the cassette, and the printer being configured to perform printing on the print medium;
a die set configured to connect a front member covered with the print medium and a back member to each other to manufacture a button product; and
a conveyor that is configured to convey the print medium from the printer to above the front member in the die set, the conveyor being configured to be attached to and detached from the housing,
wherein a direction in which the cassette is pulled out from the first accommodation chamber and a detachment direction in which the conveyor is detached from the housing are the same.

### BRIEF DESCRIPTION OF DRAWINGS

FIG. 1 is a perspective view illustrating a button product manufacturing device.

FIG. 2 is a top view of the button product manufacturing device.

FIG. 3 is a block diagram illustrating a configuration of a control system of the button product manufacturing device.

FIG. 4A is a top view of a print medium.

FIG. 4B is a top view of a white film.

FIG. 5A is a perspective view of a front member and a back member.

FIG. 5B is a cross-sectional view of a button product.

FIG. 6 is a perspective view of the button product manufacturing device in which a conveying unit is detached from a housing.

FIG. 7 is a perspective view of the button product manufacturing device in which a cassette of the print medium is drawn out from a first accommodation chamber.

FIG. 8 is a perspective view of the button product manufacturing device in which a second opening of a second accommodation chamber is opened and an ink cartridge is drawn out from the second accommodation chamber.

FIG. 9 is a perspective view of the button product manufacturing device in which a third opening of a third accommodation chamber is opened.

FIG. 10 is a perspective view of the button product manufacturing device in which a collection container is detached from the conveying unit.

FIG. 11 is a view of a part of the conveying unit viewed from left.

FIG. 12 is a cross-sectional view schematically illustrating the second accommodation chamber and the third accommodation chamber.

### DESCRIPTION

### <Button Product Manufacturing Device>

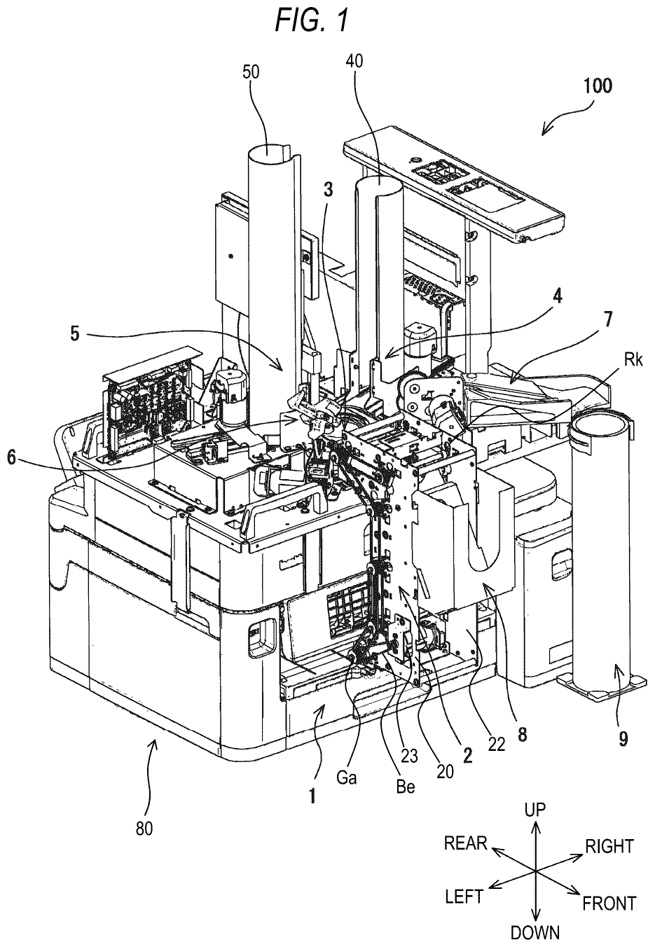

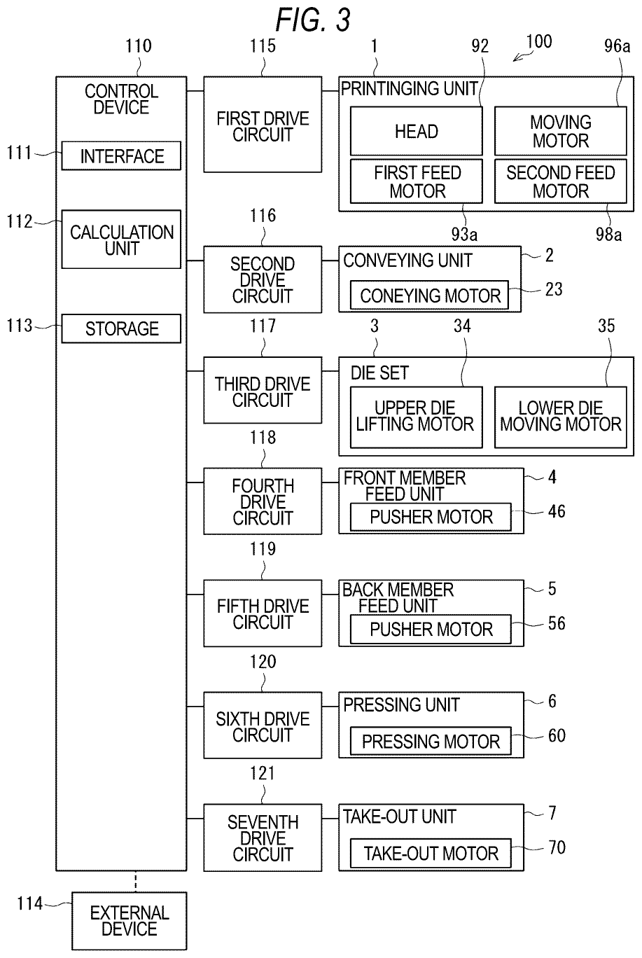

As illustrated in FIG. 1, a button product manufacturing device 100 according to an embodiment of the present disclosure includes a printing unit 1, a conveying unit 2, a die set 3, a front member feed unit 4, a back member feed unit 5, a pressing unit 6, a take-out unit 7, a collection container 8, a button product stocker 9, and a control device 110 (FIG. 3). The printing unit 1 includes a housing 80. The conveying unit 2 is configured to be attached to and detached from the housing 80. Hereinafter, a detachment direction in which the conveying unit 2 is detached from the housing 80 is referred to as front, and a direction opposite to the front is referred to as rear. Further, directions intersecting (for example, orthogonal to) the detachment direction and intersecting (for example, orthogonal to) each other are referred to as an upper-lower direction and a left-right direction. However, an arrangement direction of the button product manufacturing device 100 is not limited to these directions.

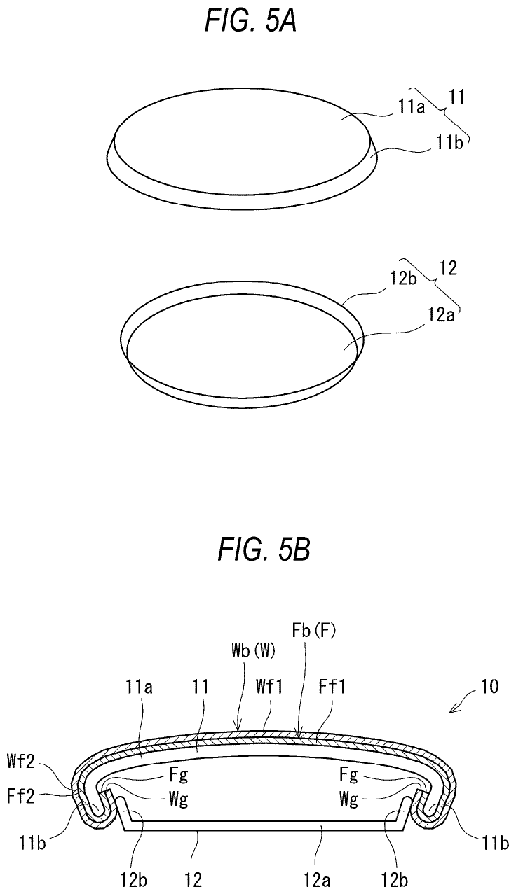

As illustrated in FIG. 5B, the button product manufacturing device 100 is a device configured to manufacture a button product 10 by connecting (caulking) a front member 11 covered with a white film F and a print medium W and a back member 12. The button product 10 is, for example, a button badge, and is manufactured from the front member 11, the back member 12, the white film F, and the print medium W. The front member 11 and the back member 12 are button members and are formed of a magnetic material such as a tin-plated steel plate. As illustrated in FIG. 5A, the front member 11 includes a front plate portion 11a having a circular shape when viewed from above, and an annular front edge portion 11b protruding downward from an outer peripheral edge of the front plate portion 11a. The back member 12 includes a back plate portion 12a having a circular shape when viewed from above, and an annular back edge portion 12b protruding upward from an outer peripheral edge of the back plate portion 12a.

As illustrated in FIG. 5B, a cover portion Fb of the white film F is disposed on a front surface of the front member 11, and a cover portion Wb of the print medium W is disposed on the white film F. Of the cover portions Wb and Fb, a portion protruding from a front surface of the front plate portion 11a is bent downward from the outer peripheral edge of the front plate portion 11a to cover a front surface of the front edge portion 11b, and a portion protruding from the front surface of the front edge portion 11b is bent upward from a lower end of the front edge portion 11b to be sandwiched between a back surface of the front edge portion 11b and the back edge portion 12b of the back member 12. Then, the button product 10 is manufactured by deforming (for example, caulking) at least one of the front member 11 and the back member 12 in a state in which the cover portions Wb and Fb are sandwiched between the front edge portion 11b and the back edge portion 12b facing each other. The front member 11 may be covered with only the print medium W without using the white film F in the button product 10.

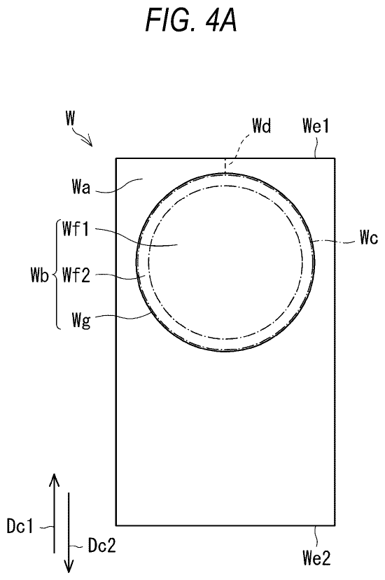

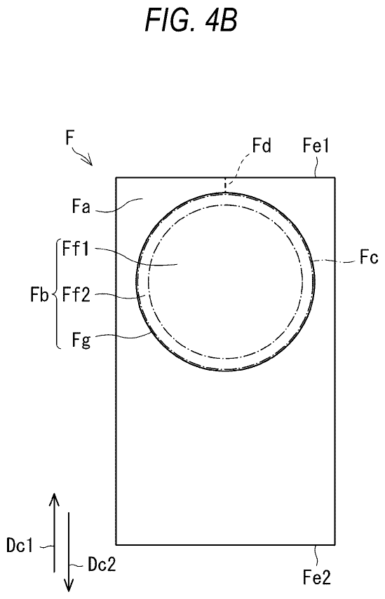

As illustrated in FIGS. 4A and 5B, the print medium W is a rectangular transparent sheet. The print medium W has a downstream end We1 and an upstream end We2 in a first conveying direction Dc1 when being conveyed toward the die set 3 by the conveying unit 2. The print medium W includes the cover portion Wb covering the front member 11, a remaining portion Wa different from the cover portion Wb, a coupling portion Wc coupling the cover portion Wb and the remaining portion Wa, and a linear weak portion Wd linearly extending from the coupling portion Wc to the downstream end We1. The cover portion Wb includes a first front portion Wf1 covering the front surface of the front plate portion 11a of the front member 11, a second front portion Wf2 covering the front surface of the front edge portion 11b, and a sandwiched portion Wg sandwiched between the back surface of the front edge portion 11b and the back edge portion 12b of the back member 12. The coupling portion Wc and the linear weak portion Wd are weak portions having a strength lower than each of strengths of the cover portion Wb and the remaining portion Wa, such as perforations. The coupling portion Wc and the linear weak portion Wd are cut by conveying the remaining portion Wa in a second conveying direction Dc2 opposite to the first conveying direction Dc1 by the conveying unit 2 in a state in which the cover portion Wb is pressed against the die set 3 by the pressing unit 6. The cover portion Wb and the remaining portion Wa are separated. According to the arrangement direction of the button product manufacturing device 100 in FIG. 1, the first conveying direction Del is rearward, and the second conveying direction Dc2 is forward.

A configuration of the white film F is basically the same as the configuration of the print medium W. As illustrated in FIG. 4B, the white film F has the same shape and size as the print medium W. The white film F includes a downstream end Fe1 and an upstream end Fe2 in the first conveying direction Dc1, a cover portion Fb, a remaining portion Fa, a coupling portion Fc, and a linear weak portion Fd. The cover portion Fb includes a first front portion Ff1, a second front portion Ff2, and a sandwiched portion Fg. The downstream end Fe1 corresponds to the downstream end We1. The upstream end Fe2 corresponds to the upstream end We2. The cover portion Fb corresponds to the cover portion Wb. The remaining portion Fa corresponds to the remaining portion Wa. The coupling portion Fc corresponds to the coupling portion Wc. The linear weak portion Fd corresponds to the linear weak portion Wd. The first front portion Ff1 corresponds to the first front portion Wf1. The second front portion Ff2 corresponds to the second front portion Wf2. The sandwiched portion Fg corresponds to the sandwiched portion Wg. A color of the white film F is not limited to white.

As illustrated in FIG. 3, the control device 110 of the button product manufacturing device 100 is a computer and includes an interface 111 that transmits and receives data to and from an external device 114, a calculation unit 112 such as a CPU that processes data, and a storage unit 113 such as a memory that stores data. The control device 110 is connected to the printing unit 1, the conveying unit 2, the die set 3, the front member feed unit 4, the back member feed unit 5, the pressing unit 6, and the take-out unit 7 via drive circuits 115 to 121, and controls operations of these units.

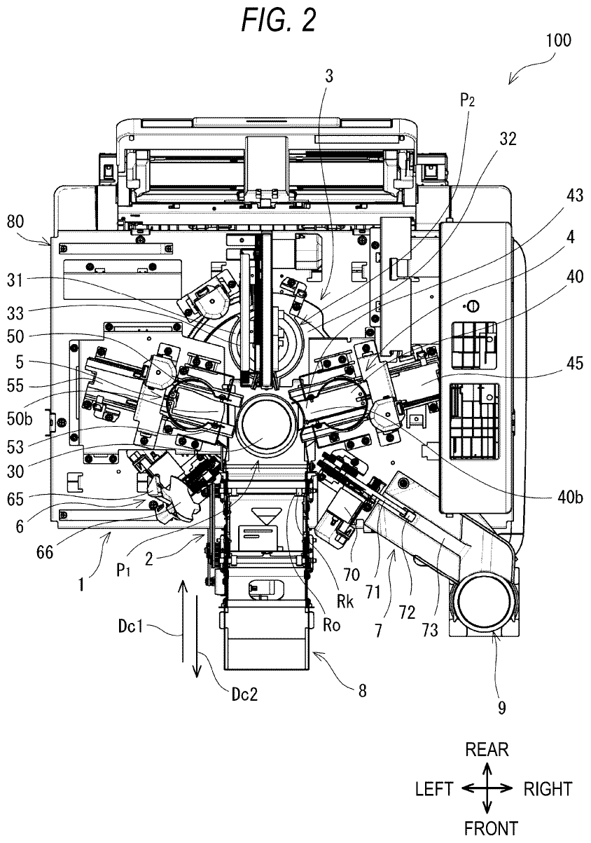

As illustrated in FIGS. 2 and 3, the front member feed unit 4 includes a front member stocker 40, a front member slider 43, a pusher 45, and a pusher motor 46. A plurality of the front members 11 are accommodated in the front member stocker 40 in a state of being stacked in the upper-lower direction. The front member slider 43 extends from a position below the front member stocker 40 to a first lower die 30 disposed at a first die position P1 of the die set 3. Driving performed by the pusher motor 46 is controlled by the control device 110 such that the pusher 45 reciprocates along the front member slider 43. Accordingly, the front member 11 is lowered from the front member stocker 40 onto the front member slider 43, is pushed toward the first lower die 30 by the pusher 45, moves on the front member slider 43, and is supplied to the first lower die 30. The front member feed unit 4 is an example of a front member feeder.

The back member feed unit 5 includes a back member stocker 50, a back member slider 53, a pusher 55, and a pusher motor 56. A plurality of the back members 12 are accommodated in the back member stocker 50 in a state of being stacked in the upper-lower direction. The back member slider 53 extends from a position below the back member stocker 50 to a second lower die 31 disposed at the first die position P1 of the die set 3. Driving performed by the pusher motor 56 is controlled by the control device 110 such that the pusher 55 reciprocates along the back member slider 53. Accordingly, the back member 12 is lowered from the back member stocker 50 onto the back member slider 53, is pushed toward the second lower die 31 by the pusher 55, moves on the back member slider 53, and is supplied to the second lower die 31. The back member feed unit 5 is an example of a back member feeder.

The printing unit 1 is, for example, an inkjet printer, and includes a head 92 and a moving motor 96a. An ejection operation performed by the head 92 and driving performed by the moving motor 96a are controlled by the control device 110. An operation of ejecting ink from the head 92 to the print medium W and an operation of moving the print medium W with respect to the head 92 by the driving performed by the moving motor 96a are executed. Accordingly, an image is printed on the cover portion Wb of the print medium W by the ink ejected from the head 92, and the print medium W is moved to the conveying unit 2. This image is inverted so as to become a normal image when a user views the image from a surface opposite to a surface on which the image is printed among surfaces of the print medium W. The printing unit 1 moves the white film F to the conveying unit 2 without printing an image on the white film F. The printing unit 1 is not limited to the inkjet printer and may be a printer such as a laser printer or a thermal printer as long as the printing unit 1 prints an image on the print medium W. The printing unit 1 is an example of a printer.

The conveying unit 2 includes a conveying motor 23, a plurality of drive rollers Rk, and a plurality of driven rollers Ro. The drive roller Rk sandwiches the print medium W and the white film F between the drive roller Rk and the driven roller Ro, and is driven by the conveying motor 23 to rotate forward to convey the print medium W and the white film F above the front member 11 in the first lower die 30 along the first conveying direction Dc1. Meanwhile, the drive roller Rk sandwiches the remaining portion Wa of the print medium W and the remaining portion Fa of the white film F between the drive roller Rk and the driven roller Ro, and is driven by the conveying motor 23 to reversely rotate to convey the remaining portions Wa and Fa to the collection container 8 along the second conveying direction Dc2. The remaining portions Wa and Fa are collected in the collection container 8 as waste portions. The driving performed by the conveying motor 23 is controlled by the control device 110. The conveying unit 2 is an example of a conveyor.

The pressing unit 6 includes a pressing motor 60, a remaining portion pressing head 65, and a pressing head 66. The remaining portion pressing head 65 and the pressing head 66 is driven by the pressing motor 60 to press the print medium W against the front member 11. In this state, by conveying the remaining portion Wa of the print medium W in the second conveying direction Dc2 by the conveying unit 2, the coupling portion Wc and the linear weak portion Wd of the print medium W are cut, and the cover portion Wb and the remaining portion Wa are separated. The cover portion Wb remains above the front member 11. The remaining portion Wa is conveyed to and collected in the collection container 8. Similarly to the print medium W, the cover portion Fb and the remaining portion Fa of the white film F are separated, the cover portion Fb remains above the front member 11, and the remaining portion Fa is conveyed to and collected in the collection container 8. The driving performed by the pressing motor 60 is controlled by the control device 110.

The die set 3 includes the first lower die 30 configured to support the front member 11, the second lower die 31 configured to support the back member 12, a rotation support table 32, an upper die lifting motor 34, a lower die moving motor 35, and an upper die 33. The rotation support table 32 is driven by the lower die moving motor 35 to pivot the first lower die 30 and the second lower die 31 to move the first lower die 30 and the second lower die 31 to the second die position P2 facing the upper die 33 or the first die position P1 other than the second die position P2. The upper die 33 is driven by the upper die lifting motor 34 to be lifted and lowered. The driving performed by the upper die lifting motor 34 and the driving performed by the lower die moving motor 35 are controlled by the control device 110.

The first lower die 30 moves to the second die position P2 below the upper die 33 after the front member 11 is supplied by the front member feed unit 4 at the first die position P1 and the cover portions Wb and Fb are conveyed above the front member 11 by the conveying unit 2. Then, the upper die 33 is lowered to the first lower die 30 to press the cover portions Wb and Fb against the front member 11, and then is lifted from the first lower die 30 to separate the front member 11 covered with the cover portions Wb and Fb from the first lower die 30. The second lower die 31 moves to the second die position P2 below the upper die 33 after the back member 12 is supplied by the back member feed unit 5 at the first die position P1. Then, the upper die 33 is lowered to the second lower die 31 to caulk (connect) the front member 11 and the back member 12 in a manner of sandwiching the sandwiched portions Wg and Fg of the cover portions Wb and Fb between the front member 11 and the back member 12. Accordingly, the button product 10 is manufactured.

The take-out unit 7 includes a take-out motor 70, a swing arm 71, a magnet member 72, and a seat portion 73. The swing arm 71 has the magnet member 72 attached to a leading end thereof, and is driven by the take-out motor 70 to be pivoted such that the magnet member 72 moves between the second lower die 31 at the first die position P1 and the seat portion 73. By pivoting the swing arm 71, the magnet member 72 adheres to the button product 10 supported by the second lower die 31, and then moves the button product 10 to the seat portion 73. The button product 10 slides down the seat portion 73 having a downward gradient into the button product stocker 9 and is stored in the button product stocker 9. The driving performed by the take-out motor 70 is controlled by the control device 110.

### <Housing>

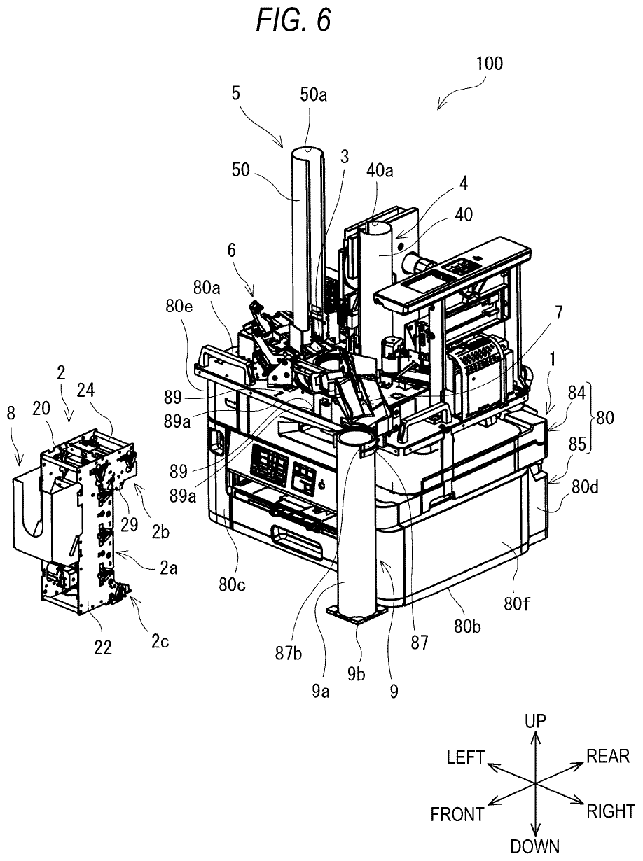

As illustrated in FIG. 6, the housing 80 provided in the printing unit 1 has, for example, a substantially rectangular parallelepiped shape, and includes a top surface 80a, a bottom surface 80b, a front surface 80c, a rear surface 80d, a left side surface 80e, and a right side surface 80f. The top surface 80a, the bottom surface 80b, the front surface 80c, the rear surface 80d, the left side surface 80e, and the right side surface 80f are, for example, rectangular flat surfaces. The top surface 80a and the bottom surface 80b are orthogonal to the upper-lower direction. The top surface 80a is disposed above the bottom surface 80b. The front surface 80c and the rear surface 80d are orthogonal to the front-rear direction. The front surface 80c is disposed in front of the rear surface 80d. The left side surface 80e and the right side surface 80f are orthogonal to the left-right direction. The left side surface 80e is disposed to the left of the right side surface 80f. For example, the die set 3, the front member feed unit 4, the back member feed unit 5, the pressing unit 6, and the take-out unit 7 are disposed on the top surface 80a of the housing 80. The control device 110 (FIG. 3) is accommodated in the housing 80. The collection container 8 and the button product stocker 9 are disposed in front of the housing 80. The conveying unit 2 is detached forward from the housing 80.

### <First Accommodation Chamber>

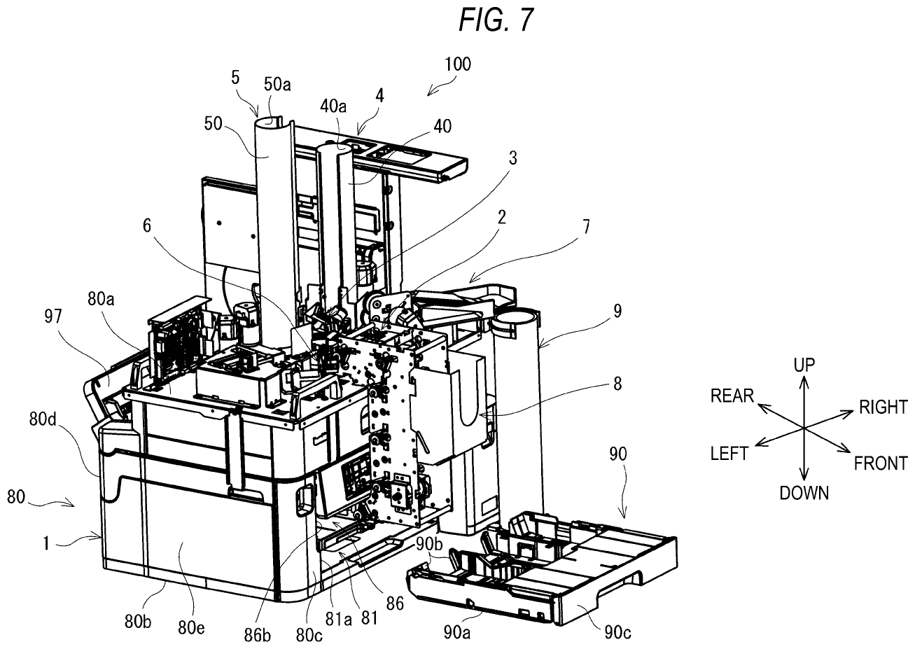

As shown in FIG. 7, the housing 80 includes a first accommodation chamber 81. A first opening 81a, which is an opening of the first accommodation chamber 81, is provided in the front surface 80c of the housing 80, and is positioned closer to the bottom surface 80b than to the top surface 80a in the upper-lower direction. The first accommodation chamber 81 is a space in which a cassette 90 for the print medium W is to be accommodated, and extends rearward from the first opening 81a in the housing 80. The cassette 90 has a box shape that opens upward, and includes a lower plate 90a that supports the print medium W, a rear plate 90b, and a front plate 90c that opens and closes the first opening 81a. The lower plate 90a has a flat plate shape intersecting (or orthogonal to) the upper-lower direction, and the print medium W is disposed on an upper surface of the lower plate 90a. The rear plate 90b is inclined or curved upward toward the rear from a rear end of the lower plate 90a. The front plate 90c rises upward from a front end of the lower plate 90a and covers the first opening 81a in a state in which the cassette 90 is accommodated in the first accommodation chamber 81. When the cassette 90 is pulled out from the first accommodation chamber 81, the first opening 81a is opened.

A user moves the cassette 90 forward from the first accommodation chamber 81 and pulls the cassette 90 out of the first accommodation chamber 81. The user stacks a plurality of the printed media W in the upper-lower direction, disposes the printed media W on the lower plate 90a of the cassette 90, and accommodates the printed media W in the cassette 90. The user moves the cassette 90 in which the plurality of printed media W are accommodated rearward from the first opening 81a and inserts the cassette 90 into the first accommodation chamber 81. Accordingly, the cassette 90 is accommodated in the first accommodation chamber 81, and the plurality of printed media W are loaded into the housing 80. As described above, by moving the cassette 90 forward or rearward, the user can perform, from the front of the housing 80, an operation of refilling the cassette 90 with the print medium W and the operation of loading the print medium W into the housing 80, and thus it is possible to improve convenience of these operations. Since a direction in which the cassette 90 is pulled out from the first accommodation chamber 81 and a direction in which the conveying unit 2 is detached from the housing 80 are both the same as the front, the user can perform, from the front of the housing 80, the operation of refilling the cassette 90 with the print medium W and the operation of detaching the conveying unit 2, and thus it is possible to improve convenience of these operations.

### <Second Accommodation Chamber>

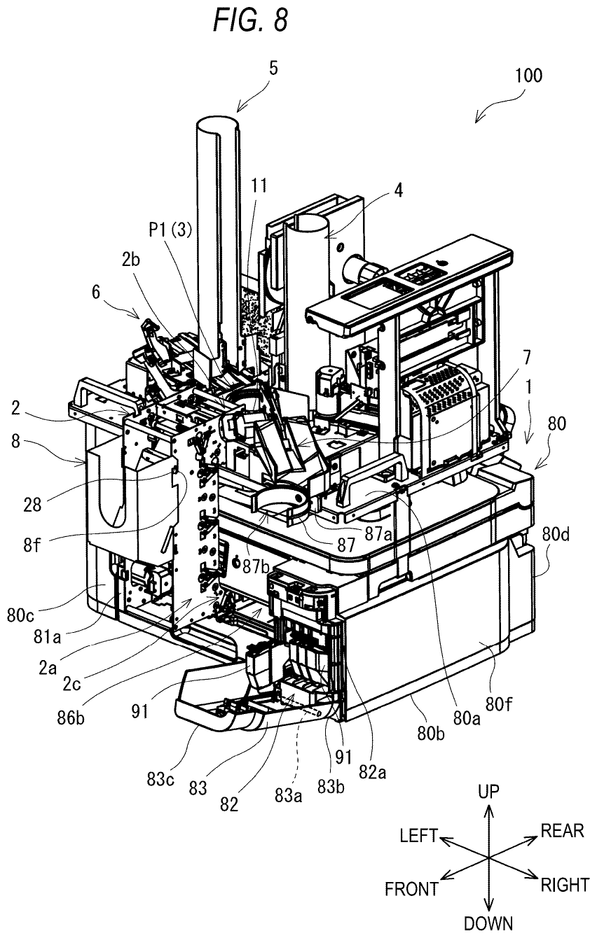

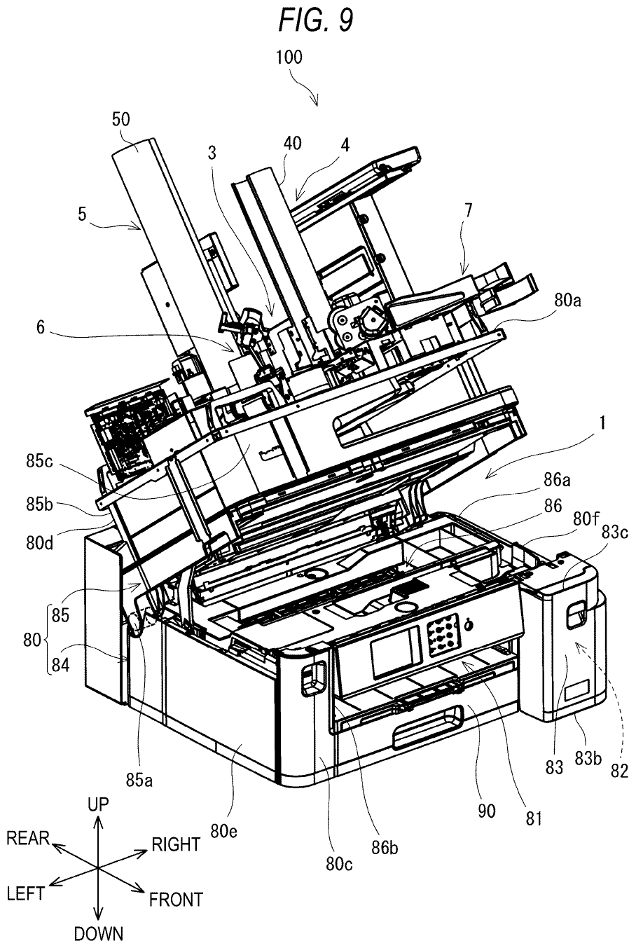

As illustrated in FIGS. 8 and 9, the housing 80 includes a second accommodation chamber 82 and a first cover 83. A second opening 82a, which is an opening of the second accommodation chamber 82, is provided on the front surface 80c of the housing 80 to the right of the first opening 81a. The second accommodation chamber 82 is a space in which an ink cartridge 91 is to be accommodated, and extends rearward from the second opening 82a in the housing 80. In the example of FIG. 8, four cartridges 91 are arranged in the left-right direction in the second accommodation chamber 82.

The first cover 83 is attached to the housing 80 to be capable of opening and closing the second opening 82a by being pivoted about a first shaft 83a extending in the left-right direction. For example, the first cover 83 includes the first shaft 83a, a first proximal end 83b, and a first distal end 83c. The first shaft 83a has, for example, a columnar shape extending in the left-right direction, is closer to a lower end than to an upper end of the second opening 82a in the upper-lower direction, and is provided at a lower portion of the first cover 83 in a closed state in which the first cover 83 covers the second opening 82a. The first proximal end 83b is an end of the first cover 83 which is closer to the first shaft 83a in a direction intersecting (for example, orthogonal to) the left-right direction. The first distal end 83c is an end of the first cover 83 which is farther from the first shaft 83a than the first proximal end 83b in the direction intersecting (for example, orthogonal to) the left-right direction.

The housing 80 has an insertion hole into which the first shaft 83a is to be inserted, and supports the first shaft 83a at an edge of the insertion hole such that the first shaft 83a is rotatable. The first cover 83 is configured to be pivoted about the first shaft 83a between a first open position and a first closed position. The first cover 83 is configured to open the second opening 82a at the first open position and covers the second opening 82a at the first closed position. As the first cover 83 is configured to move from the first closed position to the first open position, the first distal end 83c of the first cover 83 is configured to be lowered while moving forward. Therefore, the first distal end 83c at the first open position is located forward of and below the first proximal end 83b at the first closed position. That is, the first distal end 83c is located downstream of the first proximal end 83b at the first closed position in the detachment direction in which the conveying unit 2 is detached from the housing 80. In the above configuration, the first shaft 83a is provided in the first cover 83 and the insertion hole is provided in the housing 80, but the first shaft 83a may be provided in the housing 80 and the insertion hole may be provided in the first cover 83.

The cartridge 91 is a container in which ink is stored, and has, for example, a substantially rectangular parallelepiped shape. As the cartridge 91 is accommodated in the second accommodation chamber 82, the ink is supplied to the head 92 (FIG. 3). In a case where the ink in the cartridge 91 decreases and the cartridge 91 becomes empty in response to the ejection operation performed by the head 92, the user pivots the first cover 83 to the first open position so that the first distal end 83c moves forward, thereby opening the second opening 82a. The user takes out the empty cartridge 91 from the second accommodation chamber 82 through the second opening 82a, and accommodates the cartridge 91 filled with the ink in the second accommodation chamber 82 through the second opening 82a. The user pivots the first cover 83 to the first closed position so that the first distal end 83c moves rearward, thereby covering the second opening 82a by the first cover 83.

As described above, by moving the first distal end 83c of the first cover 83 forward or rearward, the user can perform, from the front of the housing 80, the operation of opening and closing the second opening 82a and the loading operation for the cartridge 91, and thus it is possible to improve convenience of these operations. Since a direction in which the first distal end 83c of the first cover 83 is moved forward to open the second opening 82a and the direction in which the conveying unit 2 is detached from the housing 80 are both the same as the front, the user can perform, from the front of the housing 80, the loading operation for the cartridge 91 and the operation of detaching the conveying unit 2, and thus it is possible to improve convenience of these operations.

Since the second opening 82a is provided in the front surface 80c of the housing 80, the cartridge 91 is configured to be taken out of the second accommodation chamber 82 from the second opening 82a along the front. Accordingly, the user moves the empty cartridge 91 forward from the second accommodation chamber 82 and takes out the empty cartridge 91 from the second accommodation chamber 82 through the second opening 82a. The user moves the cartridge 91 filled with the ink rearward from the second opening 82a and accommodates the cartridge 91 in the second accommodation chamber 82 through the second opening 82a. As described above, since a direction in which the cartridge 91 is taken out from the second accommodation chamber 82 and the direction in which the conveying unit 2 is detached from the housing 80 are both the same as the front, the user can perform, from the front of the housing 80, the loading operation for the cartridge 91 and the operation of detaching the conveying unit 2, and thus it is possible to improve convenience of these operations.

### <Third Accommodation Chamber>

As shown in FIG. 9, the housing 80 includes a main body 84 and a second cover 85. The main body 84 has a rectangular parallelepiped shape, and is provided with the first accommodation chamber 81, the second accommodation chamber 82, and a third accommodation chamber 86. The second cover 85 has a rectangular flat plate shape, and is attached to the main body 84 to be capable of opening and closing a third opening 86a, which is an upper opening of the third accommodation chamber 86, by being pivoted about a second shaft 85a. An upper surface of the second cover 85 forms the top surface 80a of the housing 80. A lower surface of the main body 84 forms the bottom surface 80b of the housing 80. A front surface of the main body 84 and a front surface of the second cover 85 form the front surface 80c of the housing 80. A rear surface of the main body 84 and a rear surface of the second cover 85 form the rear surface 80d of the housing 80. The left side surface 80e of the main body 84 and the left side surface 80e of the second cover 85 form the left side surface 80e of the housing 80. The right side surface 80f of the main body 84 and the right side surface 80f of the second cover 85 form the right side surface 80f of the housing 80. In a closed state in which the second cover 85 covers the third opening 86a, the second cover 85 is disposed on the main body 84, and a lower surface of the second cover 85 faces an upper surface of the main body 84.

The second cover 85 includes the second shaft 85a, a second proximal end 85b, and a second distal end 85c. The second shaft 85a has, for example, a columnar shape extending in the left-right direction, is closer to the rear surface than to the front surface of the second cover 85 in the front-rear direction, and is disposed rearward of the third accommodation chamber 86. For example, the second cover 85 is provided with a pair of flat protruding plates respectively protruding downward from a left rear portion and a right rear portion of the second cover 85. The pair of protruding plates are disposed at an interval in the left-right direction. The second shaft 85a is attached to the pair of protruding plates to span therebetween. The second proximal end 85b is an end of the second cover 85 closer to the second shaft 85a in the direction intersecting (for example, orthogonal to) the left-right direction. The second distal end 85c is an end of the second cover 85 farther from the second shaft 85a than the second proximal end 85b in the direction intersecting (for example, orthogonal to) the left-right direction.

The main body 84 has an insertion hole into which the second shaft 85a is to be inserted, and supports the second shaft 85a at an edge of the insertion hole such that the second shaft 85a is rotatable. Accordingly, the second cover 85 is configured to be pivoted about the second shaft 85a between a second open position and a second closed position. The second cover 85 is configured to open the third opening 86a at the second open position and covers the third opening 86a at the second closed position. As the second cover 85 moves from the second closed position to the second open position, the front surface of the second cover 85 is lifted while moving rearward. Therefore, the front surface of the second cover 85 is located above the front surface of the main body 84 at the second open position, and thus the user can access the third accommodation chamber 86 from the front of the housing 80 through a space between the front surface of the second cover 85 and the front surface of the main body 84.

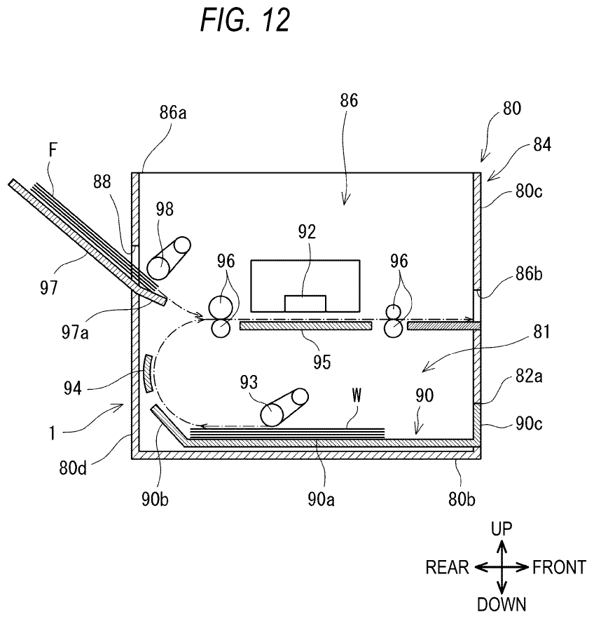

As shown in FIG. 12, the third opening 86a which is the opening of the third accommodation chamber 86 is provided on the upper surface of the main body 84. The third accommodation chamber 86 is a space in which the head 92 is to be accommodated, and extends downward from the third opening 86a in the housing 80. The third accommodation chamber 86 is disposed above the first accommodation chamber 81 and communicates with the first accommodation chamber 81. The print medium W is supplied from the cassette 90 accommodated in the first accommodation chamber 81 to the third accommodation chamber 86. An image is printed on the print medium W by the head 92 in the third accommodation chamber 86. The main body 84 is provided with a discharge port 86b through which the print medium W printed by the head 92 is discharged from the third accommodation chamber 86. The discharge port 86b is disposed above the first opening 81a in the front surface of the main body 84. The third accommodation chamber 86 communicates with the outside of the main body 84 via the discharge port 86b.

The first accommodation chamber 81 is provided with a first feed roller 93 in addition to the cassette 90. The third accommodation chamber 86 is provided with a curved wall 94, a platen 95, upstream moving rollers 96, and downstream moving rollers 96 in addition to the head 92. The first feed roller 93 is driven by a first feed motor 93a (FIG. 3) to rotate about an axis extending in the left-right direction. The upstream moving rollers 96 and the downstream moving rollers 96 are driven by the moving motor 96a (FIG. 3) to rotate about respective axes extending in the left-right direction. The driving performed by the first feed motor 93a and the driving performed by the moving motor 96a are controlled by the control device 110.

The first feed roller 93 is disposed above the cassette 90, and is in contact with the uppermost print medium W among the printed media W accommodated in the cassette 90 from above. As the first feed roller 93 rotates, the print medium W moves upward and rearward along the rear plate 90b of the cassette 90, and moves from the cassette 90 to the curved wall 94. The curved wall 94 is disposed above the cassette 90 and below the upstream moving roller 96 at the rear of the upstream moving roller 96, and is curved to protrude rearward. The print medium W moves upward and rearward along the curved wall 94, then moves upward and forward, and moves to the upstream moving roller 96.

The pair of upstream moving rollers 96 are aligned in the upper-lower direction and are rearward of the platen 95, and move the print medium W onto the front platen 95 by rotating in a state in which the print medium Wis sandwiched between the upstream moving rollers 96. The platen 95 is disposed above the cassette 90 accommodated in the first accommodation chamber 81. An upper surface of the platen 95 faces a lower surface of the head 92 and supports, from below, the print medium W supplied from the cassette 90. Ink is ejected from the lower surface of the head 92 onto the print medium W on the platen 95, and an image is printed with the ink. Then, the pair of downstream moving rollers 96 are aligned in the upper-lower direction in front of the platen 95, and move the print medium W to the front discharge port 86b by rotating in a state in which the print medium W is sandwiched between the downstream moving rollers 96. Then, the print medium Wis discharged from the discharge port 86b to the conveying unit 2.

As described above, the print medium W moves from the cassette 90, through a gap between the head 92 and the platen 95, to the discharge port 86b. For example, when a failure such as a jam occurs during the movement, as illustrated in FIG. 9, the user detaches the conveying unit 2 from the front surface 80c of the housing 80, then moves the second cover 85 from the second closed position to the second open position, and accesses a failure portion in the third accommodation chamber 86 from the space between the front surface of the second cover 85 and the front surface of the main body 84 through the third opening 86a. When the failure is the jam, the user removes the print medium W to solve the failure. Then, the user moves the second cover 85 from the second open position to the second closed position, and attaches the conveying unit 2 to the front surface 80c of the housing 80. As described above, by moving the front surface of the second cover 85 upward or downward, the user can perform, from the front of the housing 80, the operation of opening and closing the third opening 86a and the access to the failure portion in the third accommodation chamber 86, and thus it is possible to improve convenience of these operations.

### <Conveying Unit>

As illustrated in FIG. 6, the conveying unit 2 includes a first support plate 20 and a second support plate 22. The support plates 20 and 22 have a flat plate shape orthogonal to the left-right direction, are spaced apart from each other in the left-right direction, and are connected by a plurality of rods 24 extending in the left-right direction. Each of the support plates 20 and 22 includes an extending portion 2a extending in an upper-lower direction, an upper rear portion 2b extending rearward from an upper portion of the extending portion 2a, and a lower rear portion 2c extending rearward from a lower portion of the extending portion 2a.

As illustrated in FIG. 8, in a state in which the conveying unit 2 is attached to the housing 80, the extending portion 2a is disposed in front of the front surface 80c of the housing 80, the upper rear portion 2b is disposed on the top surface 80a of the housing 80, and the lower rear portion 2c is inserted into the discharge port 86b of the housing 80. The upper rear portion 2b is disposed in front of the first die position P1 of the die set 3, and thus the print medium W conveyed by the conveying unit 2 is conveyed onto the front member 11 at the first die position P1. Since the lower rear portion 2c is inserted into the discharge port 86b, the print medium W on which an image is printed by the head 92 in the third accommodation chamber 86 in the housing 80 is supplied to the conveying unit 2 through the discharge port 86b.

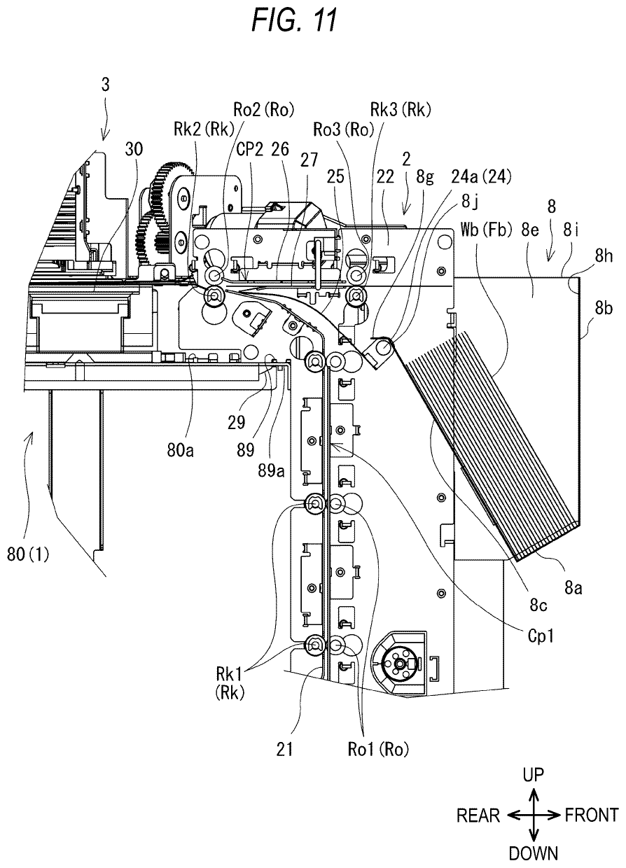

As illustrated in FIGS. 1 and 11, in the conveying unit 2, the drive roller Rk and the driven roller Ro are rotatably supported by a shaft extending in the left-right direction, and the shaft is attached to the support plates 20 and 22 to span therebetween. The drive roller Rk is connected to the conveying motor 23 via a drive gear Ga and a belt Be, and is driven by the conveying motor 23 to rotate forward or reversely rotate. Accordingly, the print medium W is sandwiched between the drive roller Rk and the driven roller Ro facing each other and is conveyed to the die set 3 or the collection container 8. The drive rollers Rk and the driven rollers Ro include first drive rollers Rk1 and first driven rollers Ro1 that convey the print medium W to the die set 3, a second drive roller Rk2 and a second driven roller Ro2 that convey the print medium W to the die set 3 or the collection container 8, and a third drive roller Rk3 and a third driven roller Ro3 that convey the print medium W to the collection container 8. Since the white film Fis conveyed by the conveying unit 2 similarly to the print medium W, the conveying for the print medium W will be representatively described below.

The conveying unit 2 further includes conveying guides 21 and 25 to 27 configured to guide the print medium W. A first conveying guide 21, a second conveying guide 25, and a third conveying guide 27 constitute a first conveying path Cp1 configured to convey the print medium W from the printing unit 1 to the first lower die 30 of the die set 3 in the first conveying direction Dc1. The third conveying guide 27 and a fourth conveying guide 26 constitute a second conveying path Cp2 configured to convey the remaining portion Wa of the print medium W from the first lower die 30 of the die set 3 to the collection container 8 in the second conveying direction Dc2. The second conveying guide 25 and the third conveying guide 27 constitute a switching unit configured to switch between the first conveying path Cp1 and the second conveying path Cp2.

The first conveying guide 21 extends upward and is then inclined obliquely upward and rearward. The second conveying guide 25 is disposed above an upper portion of the first conveying guide 21, is inclined obliquely upward and rearward, has a front end fixed to the support plates 20 and 22, and configured to be pivoted with the front end as a fulcrum. The third conveying guide 27 has a flat plate shape, is flexible, has a front end fixed to the support plates 20 and 22, and has a rear end flexible in the upper-lower direction. The fourth conveying guide 26 has a substantially plate shape and is disposed above the third conveying guide 27. The first drive rollers Rk1 and the first driven rollers Ro1 are disposed along the first conveying guide 21. The second drive roller Rk2 and the second driven roller Ro2 are disposed rearward of rear ends of the conveying guides 21 and 25 to 27. The third drive roller Rk3 and the third driven roller Ro3 are disposed in front of the third conveying guide 27 and the fourth conveying guide 26.

In the first conveying path Cp1, when the print medium W is supplied from the printing unit 1, the print medium W is sandwiched between the first drive roller Rk1 and the first driven roller Ro1 and conveyed along the first conveying guide 21, pushes up the rear end of the second conveying guide 25 and the rear end of the third conveying guide 27, and then is sandwiched between the second drive roller Rk2 and the second driven roller Ro2 and conveyed to the first lower die 30 of the die set 3. After the print medium Wis conveyed, the second conveying guide 25 and the third conveying guide 27 are lowered by their weights, and the print medium W is prevented from being conveyed to the first conveying path Cp1, thereby switching the conveying path of the print medium W from the first conveying path Cp1 to the second conveying path Cp2. Then, the remaining portion Wa of the print medium Wis sandwiched between the second drive roller Rk2 and the second driven roller Ro2 and conveyed forward, passes a gap between the fourth conveying guide 26 and a combination of the second conveying guide 25 and the third conveying guide 27, and then is sandwiched between the third drive roller Rk3 and the third driven roller Ro3 and conveyed to the collection container 8.

The conveying unit 2 is configured to be attached to and detached from the housing 80. For example, as shown in FIGS. 6 and 11, each of the first support plate 20 and the second support plate 22 of the conveying unit 2 is provided with a first engagement portion 29. The first engagement portion 29 has a substantially rectangular shape and protrudes downward from a lower end of the upper rear portion 2b of corresponding one of the support plates 20 and 22. Recesses 89 and second engagement portions 89a are provided on the top surface 80a of the housing 80. Each of the recesses 89 is recessed downward from the top surface 80a above the first accommodation chamber 81 and the discharge port 86b, and is disposed closer to a front end than to a rear end of the top surface 80a in the front-rear direction. An edge of the recess 89 in the housing 80 serves as the second engagement portion 89a and is engaged with the first engagement portion 29 fitted into the recess 89. As described above, by fitting the first engagement portion 29 into the recess 89, the user can perform, from the front of the housing 80, the operation of attaching the conveying unit 2 to the housing 80, and thus it is possible to improve convenience of the operation of attaching the conveying unit 2.

### <Collection Container>

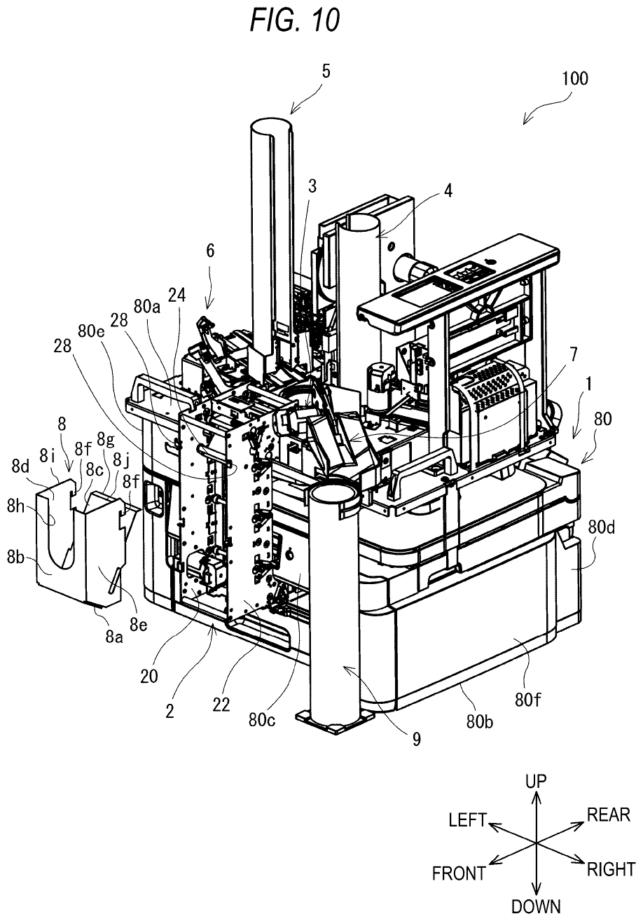

As illustrated in FIGS. 10 and 11, the button product manufacturing device 100 further includes the collection container 8. The collection container 8 is configured to accommodate the remaining portions Wa and Fa that are removed from the cover portions Wb and Fb covering the front member 11, and is disposed on the conveying unit 2 in the detachment direction. Since the remaining portion Fa of the white film F is collected in the collection container 8 similarly to the remaining portion Wa of the print medium W, the collection for the remaining portion Wa will be representatively described below.

The collection container 8 includes, for example, a substantially box shape having an opened upper portion, and includes a bottom wall 8a, a front wall 8b, a rear wall 8c, a left wall 8d, and a right wall 8e. The bottom wall 8a, the front wall 8b, the rear wall 8c, the left wall 8d, and the right wall 8e have a rectangular flat plate shape and surround an internal space of the collection container 8. The bottom wall 8a is inclined upward toward the front and is disposed forward of the conveying unit 2. The front wall 8b, the left wall 8d, and the right wall 8e rise upward from the bottom wall 8a and are disposed forward of the conveying unit 2. A take-out port 8i of the collection container 8 is opened in an upper portion of the internal space of the collection container 8, is surrounded by upper ends of the front wall 8b, the left wall 8d, and the right wall 8e, and is disposed above the top surface 80a of the housing 80 and in front of the conveying unit 2.

The rear wall 8c is inclined upward toward the rear from a rear end of the bottom wall 8a and extends between the first support plate 20 and the second support plate 22 in the conveying unit 2. In a region surrounded by the front wall 8b, the left wall 8d, and the right wall 8e, a collection port 8j of the collection container 8 is provided in front of an upper end of the rear wall 8c. The upper end of the rear wall 8c is disposed in front of and below the third drive roller Rk3 and the third driven roller Ro3. Accordingly, the remaining portion Wa of the print medium W is moved forward by the third drive roller Rk3 and the third driven roller Ro3 and then inserted (collected) into the internal space of the collection container 8 from the collection port 8j. As described above, when the remaining portion Wa is collected in the collection container 8, the user can perform, from above the housing 80, the operation of taking out the remaining portion Wa in the collection container 8 from the take-out port 8i, and thus it is possible to improve convenience of the operation of taking out the remaining portion Wa.

The front wall 8b of the collection container 8 defines a front boundary of the internal space of the collection container 8. The front wall 8b is provided with a notch 8h. The notch 8h extends downward from the take-out port 8i in the front wall 8b and communicates with the take-out port 8i. The user can visually recognize the remaining portion Wa in the collection container 8 through the notch 8h from the front of the housing 80. The user can move a hand upward along the notch 8h to lift the remaining portion Wa in the collection container 8 and take out the remaining portion Wa from the take-out port 8i. As described above, the user can perform, from the front of the housing 80, the operation of visually recognizing the remaining portion Wa and the operation of taking out the remaining portion Wa, and thus it is possible to improve convenience of these operations.

As illustrated in FIGS. 8 and 10, the collection container 8 is detachable from the conveying unit 2. For example, the third engagement portions 8f are connected to respective walls of the left wall 8d and the right wall 8e of the collection container 8. The third engagement portion 8f includes an upper portion extending rearward from a rear end of the wall and a lower portion extending downward from the upper portion. A gap is formed between the lower portion of the third engagement portion 8f and the rear end of the wall.

Meanwhile, fourth engagement portions 28 are connected to respective support plates of the first support plate 20 and the second support plate 22 of the conveying unit 2. The fourth engagement portion 28 is provided in a front portion closer to a front end than to a rear end of corresponding one of the support plates 20,22. The fourth engagement portion 28 of the first support plate 20 includes a lower portion extending leftward from the first support plate 20 and an upper portion extending upward from the lower portion. The fourth engagement portion 28 of the second support plate 22 includes a lower portion extending rightward from the second support plate 22 and an upper portion extending upward from the lower portion. A gap is formed between the upper portion of the fourth engagement portion 28 and corresponding one of the support plates 20 and 22.

The user attaches the collection container 8 to the conveying unit 2 by lowering the third engagement portion 8f of the collection container 8 onto the fourth engagement portion 28 of the conveying unit 2 and engaging the third engagement portion 8f and the fourth engagement portion 28. In contrast, the user detaches the collection container 8 from the conveying unit 2 by lifting the third engagement portion 8f from the fourth engagement portion 28 and disengaging the third engagement portion 8f and the fourth engagement portion 28. As described above, the user can perform the operation of attaching and detaching the collection container 8 from the front of the housing 80, and thus it is possible to improve convenience of the operation of attaching and detaching the collection container 8.

As illustrated in FIG. 11, the plurality of rods 24 in the conveying unit 2 include a support rod 24a. The support rod 24a is disposed in front of and below the third drive roller Rk3 and the third driven roller Ro3. The collection container 8 includes a supported portion 8g that is to be supported by the support rod 24a. The supported portion 8g has a rectangular flat plate shape, is connected to the upper end of the rear wall 8c, and extends in the left-right direction along the upper end of the rear wall 8c.

The remaining portions Wa of the printed media W are stacked on the rear wall 8c inclined obliquely forward and downward as the printed media W are collected in the collection container 8, and thus a force of the remaining portions Wa acting on the rear wall 8c increases. Meanwhile, since the rear wall 8c is supported by the support rod 24a from the rear and is hung on the support rod 24a by the supported portion 8g, the collection container 8 is held.

The supported portion 8g extends horizontally rearward from the upper end of the rear wall 8c and is disposed between the rear wall 8c and a combination of the third drive roller Rk3 and the third driven roller Ro3 in the front-rear direction. Therefore, the remaining portion Wa conveyed by the third drive roller Rk3 and the third driven roller Ro3 can be more reliably inserted into the collection port 8j in front of the rear wall 8c. The supported portion 8g is disposed above a front end of the second conveying guide 25. Accordingly, even when the remaining portion Wa is conveyed onto the second conveying guide 25 without being conveyed to the second conveying path Cp2, the remaining portion Wa can be moved from the second conveying guide 25 onto the supported portion 8g and inserted into the collection container 8.

### <Button Product Stocker>

As illustrated in FIGS. 6 and 8, the button product stocker 9 is a container in which the button product 10 is to be accommodated, and includes a third tubular body 9a and a base 9b. The third tubular body 9a has a tubular shape whose axis extends in the upper-lower direction, and is opened upward. An upper opening of the third tubular body 9a is disposed above the top surface 80a of the housing 80. The base 9b has a rectangular flat plate shape, is fixed to a lower end of the third tubular body 9a, and covers a lower opening of the third tubular body 9a.

A holder 87 that supports the third tubular body 9a is provided on the housing 80. The holder 87 is fixed to the top surface 80a of the housing 80 by a fixing portion 87a in a manner of protruding forward from the front surface 80c of the housing 80. The holder 87 has an arc shape when viewed from above, and has a front portion opened as an insertion port 87b. A dimension of the insertion port 87b in the left-right direction is smaller than a diameter of the third tubular body 9a. Since the holder 87 is flexible, the third tubular body 9a can pass through the insertion port 87b by bending the holder 87 flexible. A diameter of the holder 87 is slightly larger than the diameter of the third tubular body 9a.

The third tubular body 9a passes rearward through the insertion port 87b and is surrounded and supported by the holder 87, thereby attaching the button product stocker 9 to the housing 80. In contrast, the third tubular body 9a passes forward through the insertion port 87b and is pulled out of the holder 87, thereby detaching the button product stocker 9 from the housing 80. As described above, the user can perform, from the front of the housing 80, the operation of attaching and detaching the button product stocker 9 to and from the housing 80, and thus it is possible to improve convenience of the operation of attaching and detaching the button product stocker 9. Since a detachment direction of the button product stocker 9 is the same as the detachment direction of the conveying unit 2, it is possible to improve the convenience of these operations.

The button product stocker 9 is disposed at a position in which the button product stocker 9 prevents the movement of the first cover 83. For example, the holder 87 is disposed above and in front of the first cover 83. The third tubular body 9a supported by the holder 87 is disposed in front of the first cover 83 that covers the second opening 82a at the first closed position. Therefore, when the first cover 83 is pivoted about the first shaft 83a from the first closed position to the first open position and the first distal end 83c of the first cover 83 moves forward from the second opening 82a, the movement of the first cover 83 is prevented by the button product stocker 9. Therefore, the first cover 83 can be pivoted by detaching the button product stocker 9 from the housing 80.

A time interval for detaching the button product stocker 9 and taking out the button product 10 from the button product stocker 9 is shorter than a time interval for pivoting the first cover 83 and replacing the cartridge 91. Therefore, a decrease in operability caused by disposing the button product stocker 9 at the position in which the button product stocker 9 prevents the movement of the first cover 83 is not particularly significant. In contrast, since the button product stocker 9 is disposed at the position in which the button product stocker 9 prevents the movement of the first cover 83, it is possible to prevent increase in a size of the button product manufacturing device 100 in the left-right direction and the upper-lower direction, and the operation of taking out the button product 10 by attaching and detaching the button product stocker 9 and the operation of replacing the cartridge 91 by opening and closing the first cover 83 can be performed from the front of the housing 80, and thus it is possible to improve the convenience of these operations.

### <Tray>

As illustrated in FIGS. 7 and 12, the printing unit 1 includes a tray 97 that supports the white film F that is to be disposed between the front member 11 and the print medium W in the button product 10. The tray 97 has a rectangular flat plate shape, is disposed on rearward of the housing 80, and is inclined upward toward the rear from the rear surface 80d of the housing 80. A distance between the tray 97 and the rear surface 80d of the housing 80 in the front-rear direction increases as it moves upward. A space between the tray 97 and the rear surface 80d of the housing 80 opens upward. The white film F is inserted from an opening between the tray 97 and the rear surface 80d and is disposed on the tray 97. Accordingly, the user can perform, from above the housing 80, the operation of refilling the tray 97 with the white film F, and thus it is possible to improve convenience of the operation.

The rear surface 80d is provided with a feed port 88. A lower end of the tray 97 is connected to the rear surface 80d below the feed port 88. The space between the tray 97 and the rear surface 80d communicates with the third accommodation chamber 86 via the feed port 88. A support base 97a and a second feed roller 98 are provided in the third accommodation chamber 86. The support base 97a is disposed to extend the tray 97 forward, and supports the white film F supplied from the tray 97 from below.

The second feed roller 98 is driven by a second feed motor 98a (FIG. 3) to rotate about an axis extending in the left-right direction. The driving performed by the second feed motor 98a is controlled by the control device 110 (FIG. 3). The second feed roller 98 is disposed above the support base 97a and is in contact with the uppermost white film F among the white films F disposed on the tray 97 and the support base 97a from above. By the rotation of the second feed roller 98, the white film F is conveyed to the front upstream moving rollers 96, passes along the platen 95 by the upstream moving rollers 96, and is discharged to the conveying unit 2 through the discharge port 86b by the downstream moving rollers 96.

### <Back Member Stocker>

As illustrated in FIGS. 2 and 6, the back member stocker 50 of the back member feed unit 5 is disposed on the top surface 80a of the housing 80, has an axis orthogonal to the top surface 80a, extends upward from the top surface 80a, and opens upward by a first loading port 50a. For example, the back member stocker 50 has a tubular shape having an axis extending in the upper-lower direction, and has a diameter slightly larger than a diameter of the back member 12.

The back member stocker 50 includes the first loading port 50a, a lower opening, and a first discharge port 50b. The first loading port 50a is an upper opening surrounded by an upper end of the back member stocker 50. The lower opening is an opening surrounded by a lower end of the back member stocker 50, and is covered by the back member slider 53. The first discharge port 50b is an opening cut upward from the lower end of the back member stocker 50. An internal space of the back member stocker 50 communicates with the outside via the first loading port 50a and the first discharge port 50b. The first discharge port 50b is located between the axis of the back member stocker 50 and the first die position P1 of the die set 3.

The user loads the back member 12 from the first loading port 50a. Accordingly, the back members 12 are stacked on the back member slider 53 along the upper-lower direction and accommodated in the back member stocker 50 such that the back plate portion 12a of each of the back members 12 is orthogonal to the upper-lower direction and the back edge portion 12b extends upward from the back plate portion 12a. As described above, the user can perform, from above the housing 80, the operation of loading the back member 12 into the back member stocker 50 from the first loading port 50a, and thus it is possible to improve convenience of the operation of loading the back member 12.

### <Front Member Stocker>

The front member stocker 40 of the front member feed unit 4 is disposed on the top surface 80a of the housing 80, has an axis orthogonal to the top surface 80a, extends upward from the top surface 80a, and is opened upward by a second loading port 40a. For example, the front member stocker 40 has a tubular shape having an axis extending in the upper-lower direction, and has a diameter slightly larger than a diameter of the front member 11.

The front member stocker 40 includes the second loading port 40a, a lower opening, and a second discharge port 40b. The second loading port 40a is an upper opening surrounded by an upper end of the front member stocker 40. The lower opening is an opening surrounded by a lower end of the front member stocker 40, and is covered by the front member slider 43. The second discharge port 40b is an opening cut upward from the lower end of the front member stocker 40. An internal space of the front member stocker 40 communicates with the outside via the second loading port 40a and the second discharge port 40b. The second discharge port 40b is located between the axis of the front member stocker 40 and the first die position P1 of the die set 3.

The user loads the front member 11 from the second loading port 40a. Accordingly, the front members 11 are stacked on the front member slider 43 along the upper-lower direction and accommodated in the front member stocker 40 such that the front plate portion 11a of each of the front members 11 is orthogonal to the upper-lower direction and the front edge portion 11b extends downward from the front plate portion 11a. As described above, the user can perform, from above the housing 80, the operation of loading the front member 11 into the front member stocker 40 from the second loading port 40a, and thus it is possible to improve convenience of the operation of loading the front member 11.

From the above description, many improvements and other embodiments of the present disclosure are apparent to those skilled in the art. Accordingly, the above description should be interpreted only as an example, and is provided for the purpose of teaching those skilled in the art the best mode for carrying out the present disclosure. Details of the structure and/or the function can be substantially changed without departing from the spirit of the present disclosure.

What is claimed is:

1. A button product manufacturing device comprising:
a printer including a housing including a cassette configured to accommodate a print medium and a first accommodation chamber configured to accommodate the cassette, and the printer being configured to perform printing on the print medium;
a die set configured to connect a front member covered with the print medium and a back member to each other to manufacture a button product; and
a conveyor that is configured to convey the print medium from the printer to above the front member in the die set, the conveyor being configured to be attached to and detached from the housing,
wherein a direction in which the cassette is pulled out from the first accommodation chamber and a detachment direction in which the conveyor is detached from the housing are the same.

2. The button product manufacturing device according to claim 1,
wherein the housing includes:
a second accommodation chamber configured to accommodate a cartridge configured to store ink used to form an image on the print medium; and
a first cover configured to move, about a first shaft extending in a direction intersecting the detachment direction, between an open position at which the first cover opens an opening of the second accommodation chamber and a closed position at which the first cover closes the opening,
the first cover includes a proximal end and a distal end with respect to the first shaft, in a direction intersecting the first shaft, and
the distal end at the open position is located downstream of the proximal end at the closed position, in the detachment direction.

3. The button product manufacturing device according to claim 2,
wherein the cartridge is configured to be taken out through the opening along the detachment direction.

4. The button product manufacturing device according to claim 1,
wherein the printer includes a head configured to eject ink onto the print medium,
the housing includes:
a third accommodation chamber configured to accommodate the head; and
a second cover configured to open and close an upper opening of the third accommodation chamber, and
the second cover is configured to be pivoted about a second shaft that extends in a direction intersecting the detachment direction at a position upstream of the third accommodation chamber in the detachment direction and.

5. The button product manufacturing device according to claim 1,
wherein the print medium includes a cover portion configured to cover the front member, and a remaining portion different from the cover portion, and
the button product manufacturing device further comprises a collection container configured to accommodate the remaining portion removed from the cover portion in a state of covering the front member, the collection container being disposed in the detachment direction with respect to the conveyor.

6. The button product manufacturing device according to claim 5,
wherein the collection container includes:
a take-out port which opens to an upper portion of an internal space of the collection container and from which the remaining portion is taken out; and
a wall that defines a boundary of the internal space in the detachment direction, and
the wall includes a notch extending from the take-out port in a direction intersecting the detachment direction.

7. The button product manufacturing device according to claim 5,
wherein the collection container is configured to be attached to and detached from the conveyor.

8. The button product manufacturing device according to claim 5,
wherein the conveyor includes:
a first support plate and a second support plate spaced apart from each other in a direction intersecting the detachment direction; and
a rod connecting the first support plate and the second support plate, and
the collection container includes a supported portion configured to be supported by the rod.

9. The button product manufacturing device according to claim 2, further comprising
a button product stocker configured to accommodate the button product,
wherein the button product stocker is disposed at a position in which the button product stocker prevents movement of the first cover.

10. The button product manufacturing device according to claim 1,
wherein the printer includes a tray configured to support a film to be disposed between the front member and the print medium in the button product, and
the tray is disposed upstream of the housing in the detachment direction, and
a space between the tray and the housing is opened upward.

11. The button product manufacturing device according to claim 1, further comprising:
a back member feeder that includes a tubular back member stocker configured to accommodate the back member, and that is configured to feed the back member to the die set,
wherein the housing includes a top surface on which the die set is to be disposed, and
the back member stocker is disposed to extend upward with respect to the top surface and includes, at an upper end, a first loading port through which the back member is loaded.

12. The button product manufacturing device according to claim 1, further comprising
a front member feeder that includes a tubular front member stocker configured to accommodate the front member and that is configured to feed the front member to the die set, wherein
the housing includes a top surface on which the die set is to be disposed, and
the front member stocker is disposed to extend upward with respect to the top surface and includes, at an upper end, a second loading port through which the front member is loaded.
